(19) United States
(12) Patent Application Publication
(10) Pub. No.: US 2005/0129322 A1
(43) Pub. Date: Jun. 16, 2005

(54) Method and system for compressing, storing, and retrieving image data

(76) Inventors: Mark Olin, Lafayette, IN (US); John J. Turek, West Lafayette, IN (US); Charles A. Bouman, West Lafayette, IN (US)

Correspondence Address: BARNES & THORNBURG, 11 SOUTH MERIDIAN, INDIANAPOLIS, IN, 46204, US

(21) Appl. No.: 10/960,382

(22) Filed: Oct. 6, 2004

Related U.S. Application Data
(60) Provisional application No. 60/509,096, filed on Oct. 6, 2003.

(51) Int. Cl. G06K 9/36

(52) U.S. Cl. 382/240

(57) ABSTRACT

A method and system for compressing, storing, and retrieving image data includes precoding a number of images, recoding a selection of image data, and decoding the image data to form an image. The precoding step includes decomposing the image into a tiered decomposition and partitioning each tier into a number of tiles. The recoding step includes restreaming the image data based on region of interest, resolution, and/or quality. The decoder may retrieve image data over a network.

This application claims priority under 35 U.S.C. § 119(e) to U.S. Provisional Application Ser. No. 60/509,096, filed on Oct. 6, 2003, the entirety of which is hereby incorporated by reference herein.

### BACKGROUND OF THE INVENTION

The present disclosure relates generally to methods and systems for compressing, storing, and retrieving data, and more particularly, to methods and systems for compressing, storing, and retrieving image data.

Data compression is a technique used to reduce the amount of space required to store the data and/or the amount of bandwidth required to transmit the data. A number of data compression techniques have been developed. Some data compression techniques are generally more suitable for specific types of data. For example, wavelet compression is often used to compress image data. As the volume of data increases, data compression becomes an increasingly important consideration for the storage and transmittal of such data. For example, high resolution images require a relatively large amount of storage space when not compressed. The storage space required increases drastically as the number of images and the number of resolutions of each image are stored.

Many applications involve the production of large or high resolution images. Such images may be stored for later retrieval, viewing, and analysis. For example, in digital microscopy, high resolution digitized image rasters or montages are often stored for later analysis. The image rasters or montages are composite image representations of matter under the lens of a microscope. An image montage collectively spans a sample of organic or inorganic matter scientifically prepared on a slide. A user may navigate such a collection by panning among multiple dissimilar regions spread randomly across the montage and refine viewed region in a coarse to fine progression. To provide the similar flexibility as the imaging modality (e.g., microscopy) provides to the user, random access to various areas of the image and a large number of resolution levels are required.

### SUMMARY OF THE INVENTION

The present invention comprises one or more of the features recited in the appended claims and/or the following features which, alone or in any combination, may comprise patentable subject matter:

A method of compressing an image is provided. The method may include decomposing the image into a number of tiers. The method may also include partitioning at least one tier into a wavelet tile. The decomposing step may include performing a number of wavelet transforms on the image. The number of tiers may include a predetermined number of wavelet decompositions of the image.

The method may further include determining a region of interest of the image. The decomposing step may include decomposing the image into a number of tiers based on the region of interest. The partitioning step may include determining a spatial orientation tree of the at least one tier. The spatial orientation tree may have a root in the highest decomposition level of the at least one tier.

The method may yet further include comprising compressing the wavelet tile. The compressing step may include zero tree compressing the wavelet tile. The method may also include storing the wavelet tile after the compression step. The storing step comprises storing the wavelet tile after the compression step based on the region of interest.

A method of distributing image data to a user is provided. The method may include determining a region of interest of an image supplied by the user. The method may also include determining a resolution of the image supplied by the user. The method may further include determining a quality level of the image supplied by the user. The method may yet further include transmitting image data to the user. The image data may be based on the region of interest, resolution, and quality level. The transmitting step may include transmitting the data over a network. The network comprises the Internet The transmitting step may include transmitting image data from a server to a client. The method may also include compressing an image to form the image data. The compressing step may include storing the image data in a database. The method may still further include decompressing the image data to form an image. The method may also include displaying the image to the user.

A system for distributing images is also provided. The system may include precoder, a recoder, and/or a decoder. The precoder may be configured to compress and store an image. The recoder may be configured to select and reorganize a portion of the image based on a region of interest value, a resolution value, and a quality level value. The recoder may transmit the portion of the image as a bit stream. The decoder may be configured to receive the bit stream and convert the bit stream to an image.

The above and other features of the present disclosure, which alone or in any combination may comprise patentable subject matter, will become apparent from the following description and the attached drawings.

### BRIEF DESCRIPTION OF THE DRAWINGS

The detailed description particularly refers to the following figures, in which:

FIG. 1 is a simplified block diagram of network-based system for compressing, storing, and retrieving image data;

FIG. 2 is a simplified process flow diagram of an algorithm for preceding, recoding, and transmitting image data used by a server of the system of FIG. 1;

FIG. 3 is a simplified process flow diagram of an algorithm for retrieving, decoding, and caching image data used by a client of the system of FIG. 1;

FIG. 4. is a simplified process flow diagram of a precode step of the algorithm of FIG. 2;

FIG. 5 is an illustration of an image montage having a number of images and defined regions of interest;

FIG. 6 is a block diagram of a two dimensional wavelet analysis filter block;

FIG. 7 is an illustration of a coefficient map of a two-dimensional, three-level wavelet decomposition;

FIG. 8 is an illustration of a three-tiered decomposition of an exemplary image;

FIG. 9 is an illustration of a two-tiered decomposition of an exemplary image;

FIG. 10 is an illustration of a three-tiered decomposition of an image montage;

FIG. 11 is a diagrammatic illustration of the formation of a wavelet domain tile;

FIG. 12 is an exemplary D-level spatial orientation tree spanning a wavelet domain tile;

FIG. 13 is a process flow diagram of a precoding step of the algorithm of FIG. 2;

FIG. 14 is a process flow diagram of a tiling step of the algorithm of FIG. 13;

FIG. 15 is a process flow diagram of a compression step of the algorithm of FIG. 13;

FIG. 16 is a process flow diagram of a recoding step of the algorithm of FIG. 2;

FIG. 17 is a process flow diagram of a restreaming step of the algorithm of FIG. 16;

FIG. 18 is a process flow diagram of a decoding step of the algorithm of FIG. 3; and

FIG. 19 is a process flow diagram of a decompression step of the algorithm of FIG. 18.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

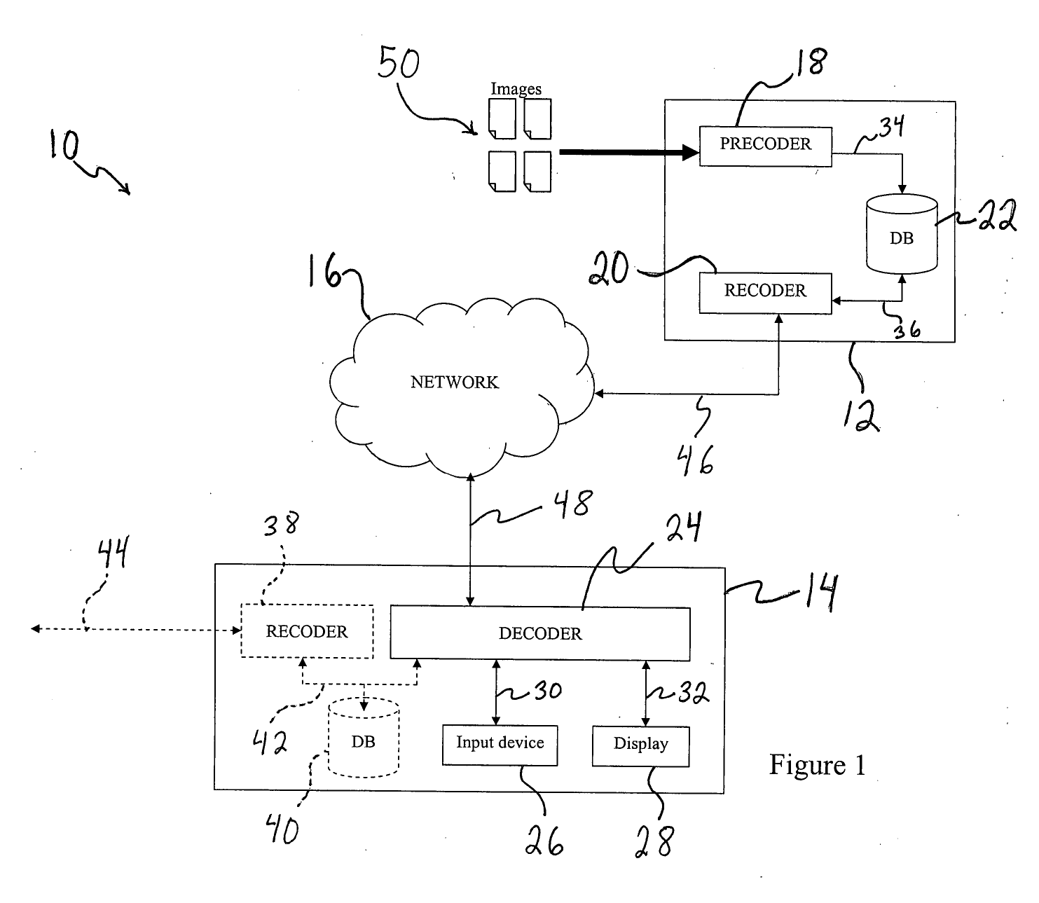

In regard to one illustrative embodiment, as shown in FIG. 1, a network-based system 10 for compressing, storing, and retrieving image data has a server machine 12 which communicates with a client machine 14 via a network 16. The network 16 may be embodied as any type of network such as a LAN, WAN, wireless network, or the like. Moreover, in a specific illustrative embodiment, the network 16 is embodied as a publicly-accessible global network such as the Internet. Although only one server 12 and one client 14 are shown in FIG. 1, it should be appreciated that the system 10 may include any number of server machines 12 and client machines 14 coupled together to form an image dissemination network.

In a conventional manner, each of the servers 12 and clients 14 includes a number of components commonly associated with such machines. For example, although not shown in detail in the drawings, each of the severs 12 and clients 14 may include, amongst other things customarily included in such machines, a central processing unit (“CPU”), a non-volatile memory such as a read only memory (“ROM”), a volatile memory such as a random access memory (“RAM”), and one or more data storage devices. It should also be appreciated that such components may be integrated into a single housing or may be provided as a number of separate, discrete devices. It should also be realized that the sever 12 and the client 14 may be operated with known, commercially available software operating systems.

As such, the server machine 12 may be embodied as any type of commercially available network server. The storage devices associated with the network server 12 maintain a number of databases and files which are utilized in the construction and operation of an information portal such as a gateway, website, or other portal. For example, the server machine 12 may include a gateway for exchanging information across networks that are incompatible and that use different protocols. The gateway may be embodied as any combination of commercially available hardware and/or software that connects different types of networks such that information can be exchanged therebetween.

The server 12 includes a precoder 18, a recoder 20, and one or more databases 22. In the illustrative embodiment, the precoder 18 and recoder 20 are embodied as software algorithms. However, in other embodiments, the precoder 18 and/or recoder 20 may be embodied as hardware devices. Although the precoder 18 is shown as included in the server 12, in some embodiments, the precoder 18 is external to the server 12. For example, the precoder 18 may be included in a separate server or other machine which is coupled to the server 12 for transmitting the precoded images. Similarly, although the database 22 is shown as stored on the server 12, in some embodiments, the database 22 may be external to the server 12. For example, the database 22 may be embodied as a separate database server or storage device. The precoder 18 is coupled to the database 22 via a communication link 34. The recoder 20 is also coupled to the database via a communication link 36. The communication links 34, 36 may be embodied as wires, cables, traces, or the other electrical interconnects.

The client 14 includes a decoder 24, an input device 26 such as a keyboard and/or mouse, and a display 28 such as a monitor or the like. The input device 26 and display 28 are coupled to the decoder 24 via communication links 30, 32, respectively. The decoder 24 is illustratively embodied as a software algorithm, but in other embodiments, may be embodied as a hardware device. In some embodiments, the client 14 may also include a recoder 38 similar to recoder 20 and a database 40. In such embodiments, the recoder 38 and the decoder 24 are coupled to the database 40 via communication links 42. The recoder 38 may also be coupled to client machines, computers, or the like via a communication link 44.

As shown in FIG. 1, the network server 12 is coupled to the network 16 via a communications link 46, whereas the client 14 is coupled to the network 16 via a communications link 48. It should be appreciated that the communications links 46, 48 may be provided as any number of different types of data links including both wired and wireless data links. Moreover, it should also be appreciated that one or more intervening modems (not shown), data routers (not shown), and/or internet service providers (“ISPs”) (not shown) may be used to transfer the data between the sever machine 12 and the client machine 14.

A user may use system 10 to compress, store, and retrieve images. To do so, the user supplies a number of images 50 to the precoder 18. The images 50 may be separate, unrelated images or the images 50 may be related images such as portions of a larger image. In the latter case, each image may include overlapping portions of other images. For example, in the application of microscopy, a single slide may produce hundreds of associated images that when combined form a montage image of the slide or specimen thereon. Such images may contain overlap of related images, either by design or due to mechanical, electrical, or operator difficulties and/or limitations. Accordingly, the precoder 18 allows the user to select a region of interest of each image. The region of interest is subsequently precoded rather than the full image.

In response to an image supplied by the user, the precoder 18 constructs a multi-tiered wavelet transform of the image (or region of interest of the image) by performing a number of D-level wavelet decompositions on different resolutions of the image. The precoder 18 then partitions each tier into wavelet domain tiles (WDT). Each wavelet domain tile contains a spatial orientation tree for the D decomposition level of the related tier. Accordingly, the precoder 18 performs a hierarchical wavelet domain tiling of the image or region of interest thereof. The precoder 18 subsequently compresses the tiles and stores the compressed data in the database 22.

Once a number of images has been precoded and stored in the database 22, a user may use the client 14 to retrieve an arbitrary portion of the stored composite image. To do so, the user supplies a region of interest, a resolution level, and the desired quality of the image (e.g., bit rate or bit plane) to the client 14. The client 14 transmits the supplied data to the recoder 20 of the server 12 via the network 16. In response, the recoder 20 retrieves a selection of compressed image data from the database 22 based on the specified region of interest. The recoder 20 subsequently restreams the data to the decoder 34 based on the specified resolution and quality. The decoder 24 decompresses the restreamed data and displays the resultant image to the user via the display 28.

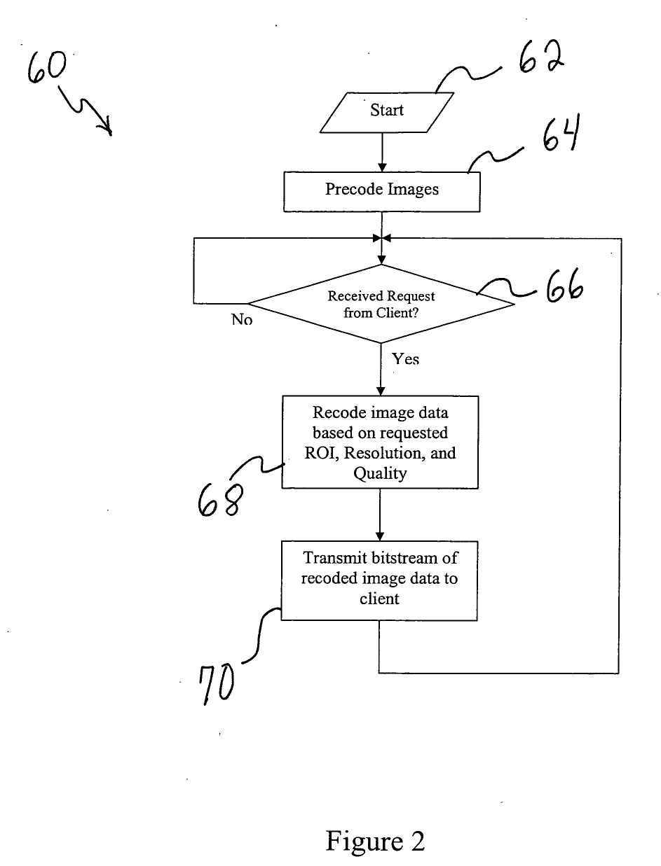

Referring now to FIG. 2, an algorithm 60 is executed by the server 12 to precode and recode image data. The algorithm 60 begins at step 62 in which variables, lists, and the like may be initialized. The algorithm 60 then advances to step 64. In step 64, a number of supplied images 50 are precoded. As discussed above, the precoder 18 tiers and tiles the images and stores the image data in a compressed format in the database 22.

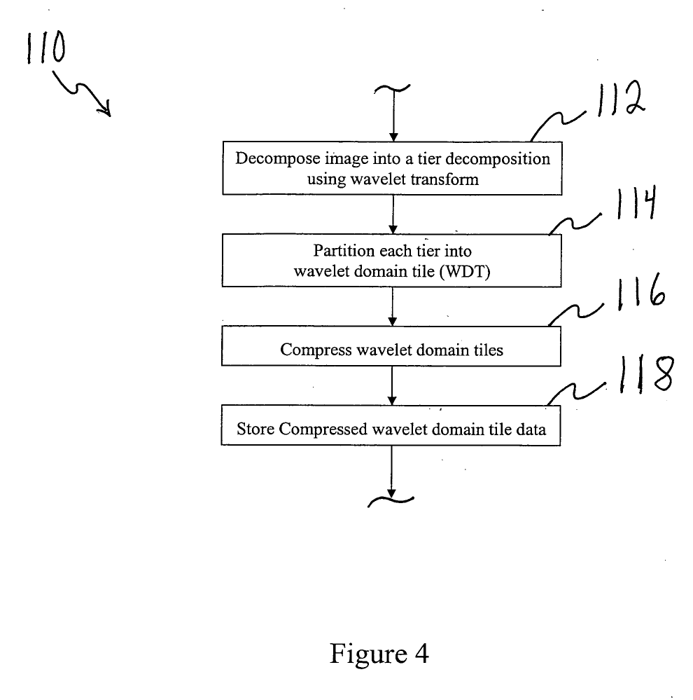

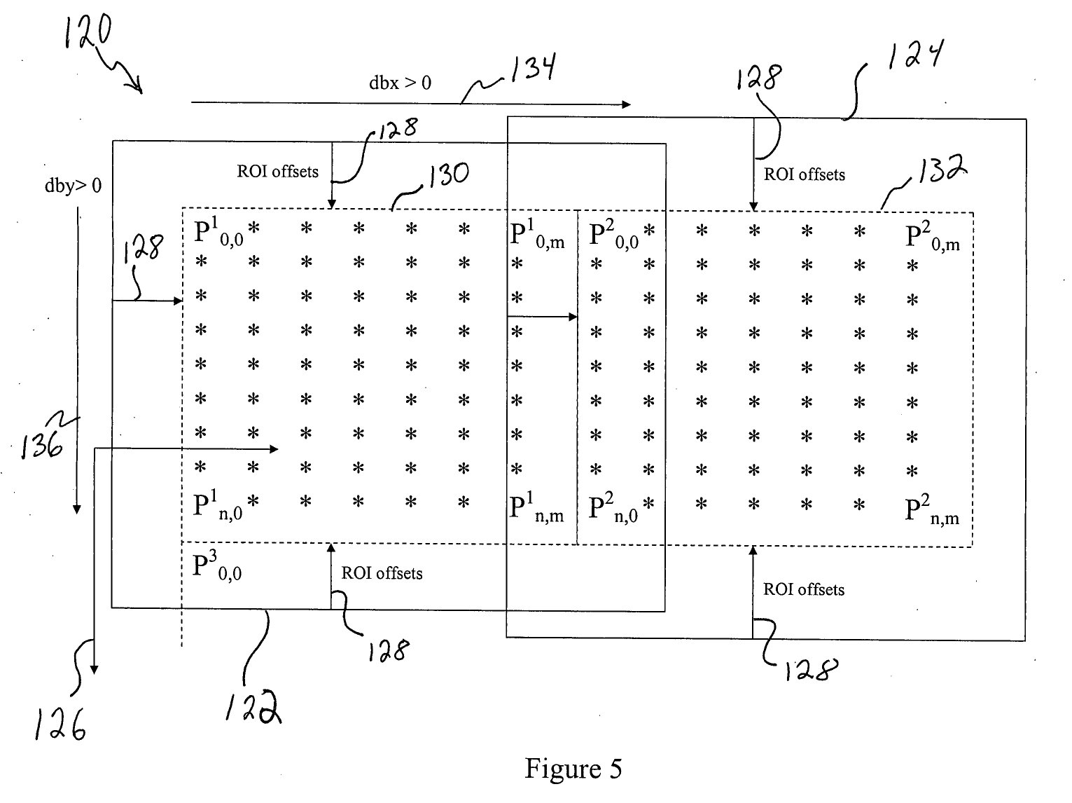

In one illustrative embodiment, an image may be precoded by use of an abstract precode algorithm 110 as shown in FIG. 4. The precode algorithm 110 begins with process step 112 in which the image is decomposed into a tier decomposition using wavelet transform. The process step 112 is described below in reference to FIGS. 5-10.

Although the term “image” is used herein, it should be understood that in some applications only a specified region of interest (i.e., a portion of the image) may be precoded, and the output appended to the database 22 of other precoded image portions. Therefore, the aggregate of all the image portions in database 22 constitute the “image”. For example, as illustrated in FIG. 5, a number of images 122, 124, 126 may form an image montage 120. The images 122, 124, 126 are each formed from a number of pixels, P^{I}, wherein I is the image number. The images 122, 124, 126 each contain imagery in common (overlapping) with one another, whereas the regions of interest do not. Accordingly, a user may specify a region of interest 130, 132 for each image. As illustrated in FIG. 5, the regions of interests 130, 132 may be so selected that they complement each other rather than overlap. A region of interest may be defined by a set of pixel or position offsets as indicated in FIG. 5 by offset arrows 128. To align the image features from two neighboring images, each region of interest 130, 132 may require different offsets relative to one another. The x coordinate offset may also be different than the y coordinate offset. Furthermore, the dimensions of each region of interest must conform to an integer multiple of the tile dimensions because the precoder will further partition the image region into wavelet domain tiles of the same size. The database offset of a given tile in database 22 is calculated from the database offset number supplied for the region of interest. Therefore, each region of interest 130, 132 is precoded with a database offset number as indicated in FIG. 5 by database offset arrows 134, 136. For example, the first tile in region of interest 130 has a x database offset number of 0, and a y database offset number of 0 since it is the first image in the database 22; the first tile in region of interest 132 has a x database offset number given by database offset arrow 134 (equal to the width of region 130), and a y database offset number of 0. Database offset arrow 136 applies to P³ of image 3. The recoder may subsequently access tiles in database 22 using client supplied database offset numbers computed from arbitrary regions of interest.

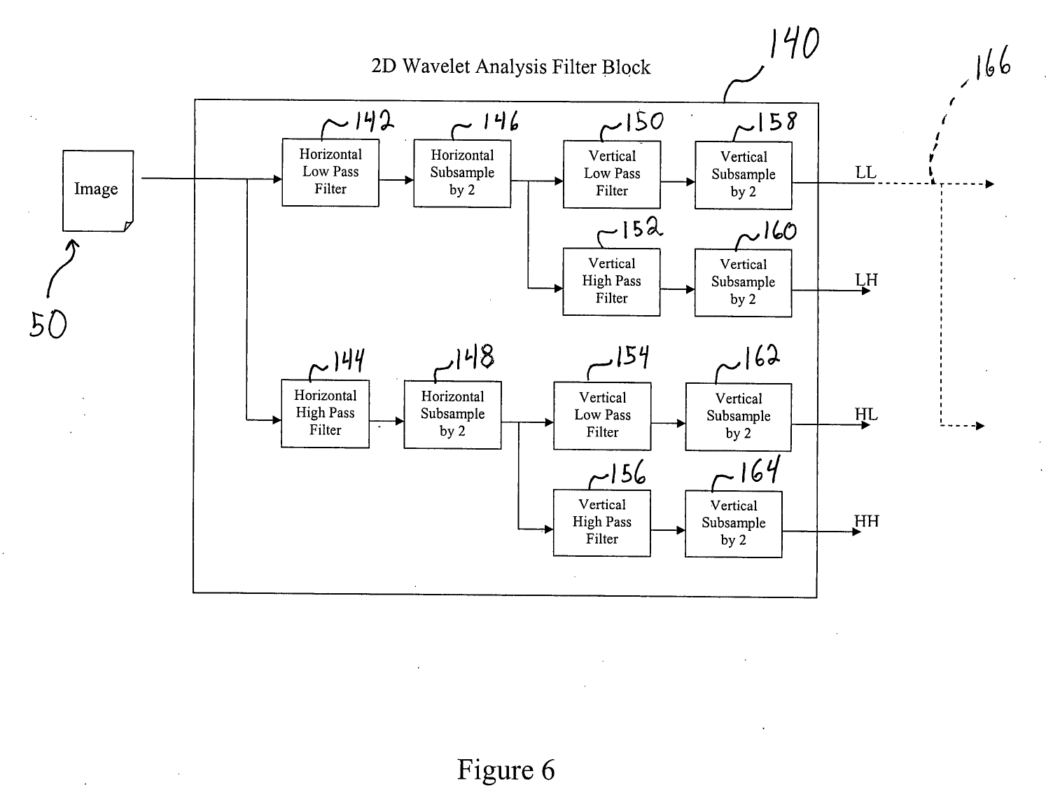

Referring now to FIG. 6, to decompose the image 50 (or region of interest thereof), a number of two dimensional wavelet analysis filter blocks 140 may be used. The number of filter blocks 140 used to decompose the image 50 depends upon the desired decomposition level. A filter block 140 is used for each desired level of decomposition. For example, to perform a three level wavelet decomposition of an image 50, three filter blocks 140 are used in a series configuration. The image 50 is supplied to the first filter block 140. The filter block 140 includes a horizontal low pass filter 142 and a horizontal high pass filter 144. The image data (i.e., pixels) is supplied to both filters 142, 144. The horizontal low pass filter 142 obtains the low frequency components of the pixel rows of the image 50. The horizontal high pass filter 144 obtains the high frequency components of the pixel rows of the image 50.

The outputs of the filters 142, 144 is supplied to horizontal subsample blocks 146, 148, respectively. The horizontal subsample blocks 146, 148 subsample the rows of the filtered image data by two and, accordingly, reduce the horizontal aspect of the image by two. The outputs of the block 146 is provided to a vertical low pass filter block 150 and a vertical low pass filter block 152. Similarly, the output of the block 148 is provided to a vertical low pass filter block 154 and a vertical low pass filter block 156. The vertical low pass filters 150, 154 obtain the low frequency components of the pixel columns of the image 50. The vertical high pass filters 152, 156 obtain the high frequency components of the pixel columns of the image 50. Each of the outputs of the filters 150, 152, 154, 156 is subsampled by two by vertical subsample blocks 158, 160, 162, 164, respectively. The coefficients produced by the block 158 form the low-low subband (LL). The coefficients produced by the block 160 form the low-high subband (LH). The coefficients produced by the block 162 form the high-low subband (HL) and the coefficients produced by the block 164 form the high-high subband (HH).

A single two-dimensional wavelet analysis filter block performs a one level decomposition on the image. However, additional filter blocks 140 can be coupled in series to perform additional levels of decomposition on the image. To do so, another filter block 140 is coupled to the LL subband of the first filter block 140 as illustrated in FIG. 6 via dashed lines 166 to perform a two level decomposition on the image. A further filter block 140 may be coupled to the LL subband output of the second filter block 140 to perform a three level decomposition of the image and so on.

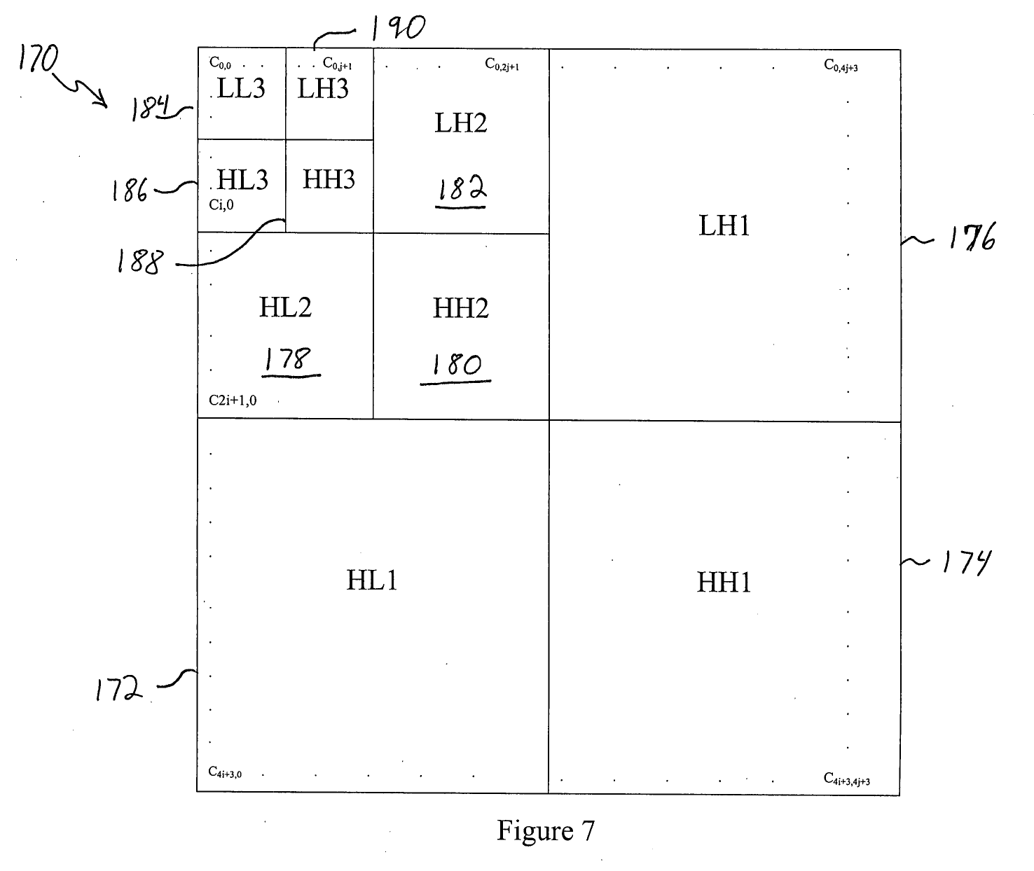

The wavelet decomposition of an image 50 produces a coefficient map 170 as illustrated in FIG. 7. The map 170 is a two-dimensional, three-level wavelet decomposition formed from, for example, a series of three filter blocks 140. The coefficients, C_{x,y}, are arranged in subbands. The two-dimensional, three-level wavelet decomposition coefficient map 170 includes a high-low level one subband 172 (HH1), a high-high level one subband 174 (HH1), and a low-high level one subband 176 (LH1). The map 170 also includes a high-low level two subband 178 (HL2), a high-high level two subband 180 (HH2), and a low-high level two subband 176 (LH2). The map 170 further includes a low-low level three subband (LL3), a high-low level three subband 172 (HH3), a high-high level three subband 174 (HH3), and a low-high level three subband 176 (LH3).

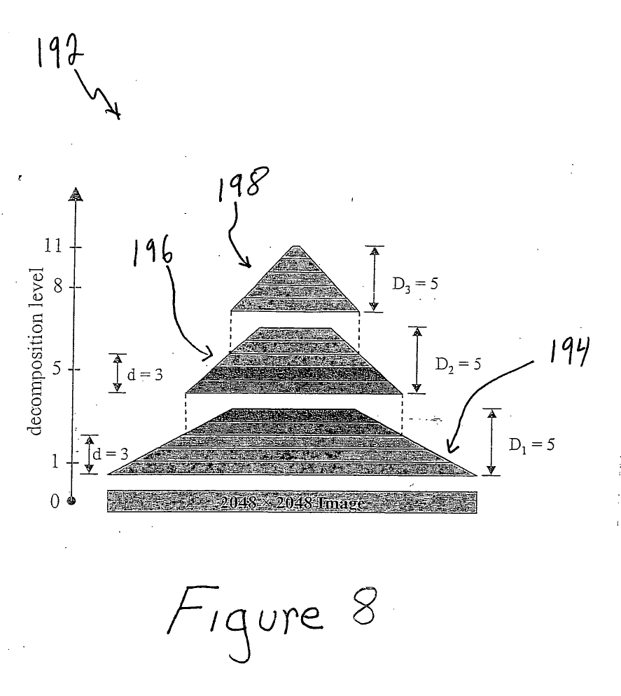

As discussed above in regard to FIG. 4, process step 112 of algorithm 110 decomposes an image into a tier decomposition. The image is decomposed into a tier decomposition based on two parameters. The parameter D is the number of levels of decomposition to be performed per tier. The parameter d is the number of image resolutions to be skipped between tiers. A three tier decomposition 192 of an exemplarily 2048 by 2048 pixel image is illustrated in FIG. 8. In a tiered decomposition, the original image information is contained in the bottom-most tier 194. The remaining tiers 196, 198 contain a copy of the image at a smaller resolution. For d=3 as in FIG. 8, the image resolution which is used to produce the middle tier 196 is a (1/2)³ scaled resolution of the original image. The top tier 198 is produced from a from a (1/2)⁶ scaled resolution. Because D is greater than d in FIG. 8, there is an overlap of equivalent image resolution content among the tiers as indicated by the shaded resolutions.

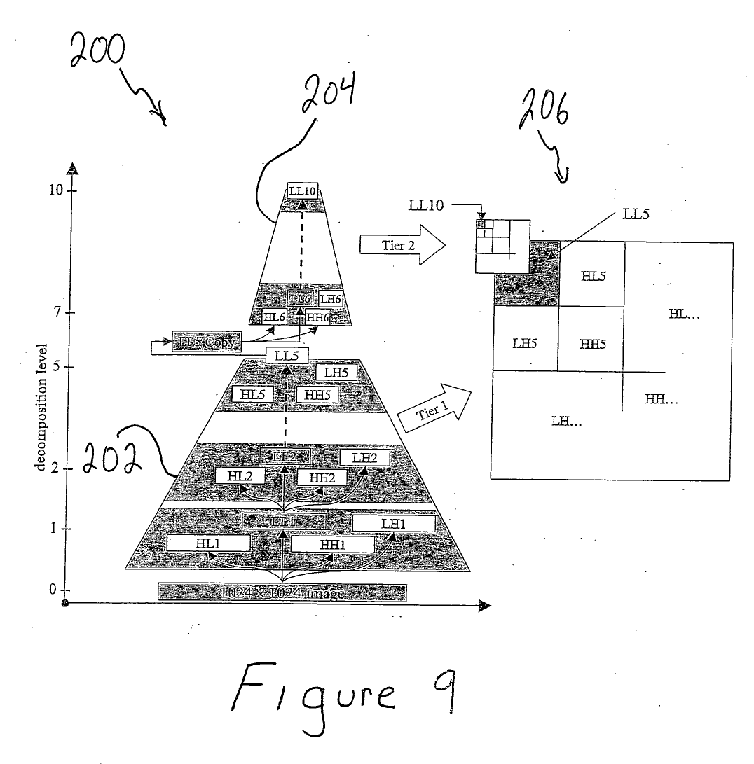

Referring now to FIG. 9, a two tier decomposition 200 of an exemplarily 2048 by 2048 pixel image is illustrated. The image is tiered with parameters D=5 and d=5. As shown in FIG. 6, the 2D Wavelet Analysis Filter block performs a vertical and horizontal subsampling of low frequency image component. Therefore, the precoder makes use of LL component output of filter 158 to supply the necessary smaller resolutions of the image. Because a new tier begins after d×(i−1) decompositions, wherein i is equal to the number of tiers, the second tier 204 begins after five levels of decomposition are performed on the image. As illustrated in FIG. 9, to obtain an initial image for the i tier, a copy is made of the coefficients contained in an intermediate low-low subband (LL). If D=d as in FIG. 9, the initial image for the i tier, wherein i>1, is formed from the LL subband coefficients of the top decomposition level of the i−1 tier. The i tier coefficients of the decomposition levels relate to a coefficient map 206 as illustrated in FIG. 9.

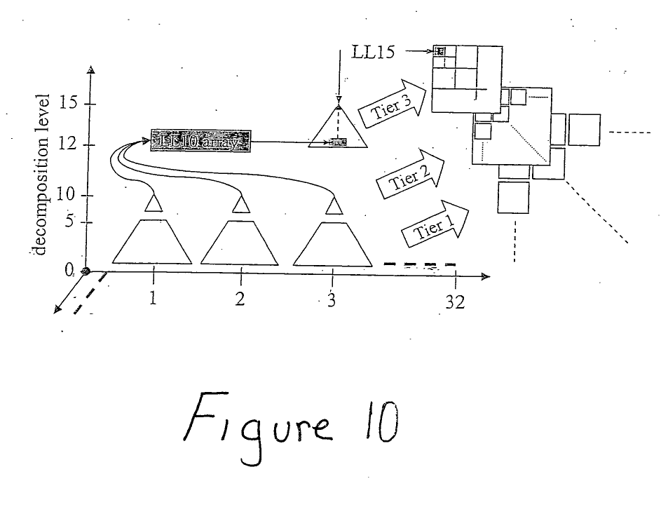

Referring now to FIG. 10, a tiered decomposition may be performed on a group of images which form an image montage without the images being combined beforehand. An exemplary 32 K×32 K composite image being formed of multiple 1024×1024 images is decomposed into tiers in FIG. 10. The two tiered configuration is extended to form a three-tiered hierarchy where the third tier decomposes a composite array of coefficients formed from multiple instances of two-tiered decompositions. In FIG. 10, two tiered decompositions with D=5 and d=5 are performed on a 32×32 grid of each 1024×1024 image. Accordingly, the first and second tiers contain a grid of decompositions. Because boundary pixels may be incorporated from neighboring images to compute the transform coefficients, partitioning of the separate decompositions into wavelet domain tiles produces similar results as if the images were combined beforehand into a single 32 K×32 K composite image.

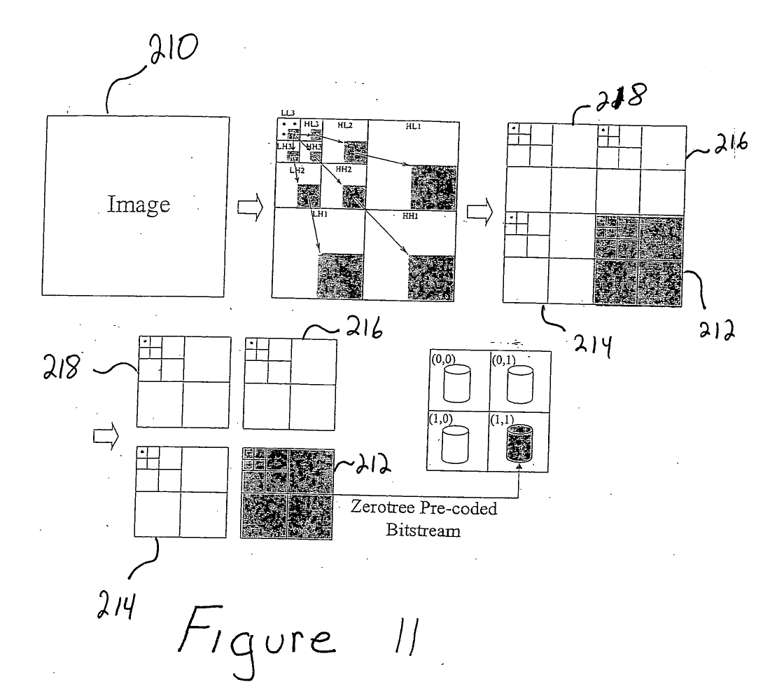

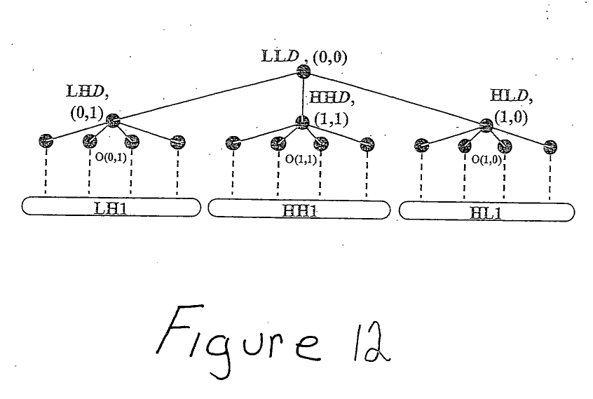

Now referring back to FIG. 4, after the image has been decomposed into tiers in process step 112, the algorithm 110 advances to process step 114. In process step 114, each tier is partitioned into wavelet domain tiles. A wavelet domain tile is a single spatial orientation tree having a root residing in the LLD subband of the decomposition. For example, referring to FIG. 11, a three level decomposition is performed on the illustrative image 210. Because the LL3 subband contains four coefficients, the image 210 is tiled into four wavelet domain tiles 212, 214, 216, and 218. Therefore the size of each wavelet domain tile is exactly one-fourth the size of the input image (region). To organize a wavelet domain tile, a spatial orientation tree is found for each coefficient in the LL3 subband wherein the coefficient forms the root of the spatial orientation tree. An exemplary spatial orientation tree for coefficient (0,0) of the LL3 subband is illustrated in FIG. 12. Each tree has a root in the LL3 subband and has descendents in lower decomposition levels. The coefficients that form a spatial orientation tree are spatially related as illustrated in FIG. 11.

Referring back to FIG. 4, after the each tier has been partitioned into wavelet domain tiles in process step 114, the algorithm 110 advances to process step 116. In process step 116, each wavelet domain tile is compressed. The algorithm 110 subsequently advances to process step 118 in which the wavelet domain tiles are stored in the database 22. Although the abstraction of the precoding algorithm 110 is illustrated in FIG. 4 as being sequentially executed, it should be appreciated that in some embodiments, some process steps of algorithm 110 may be embedded in other process steps or the like.

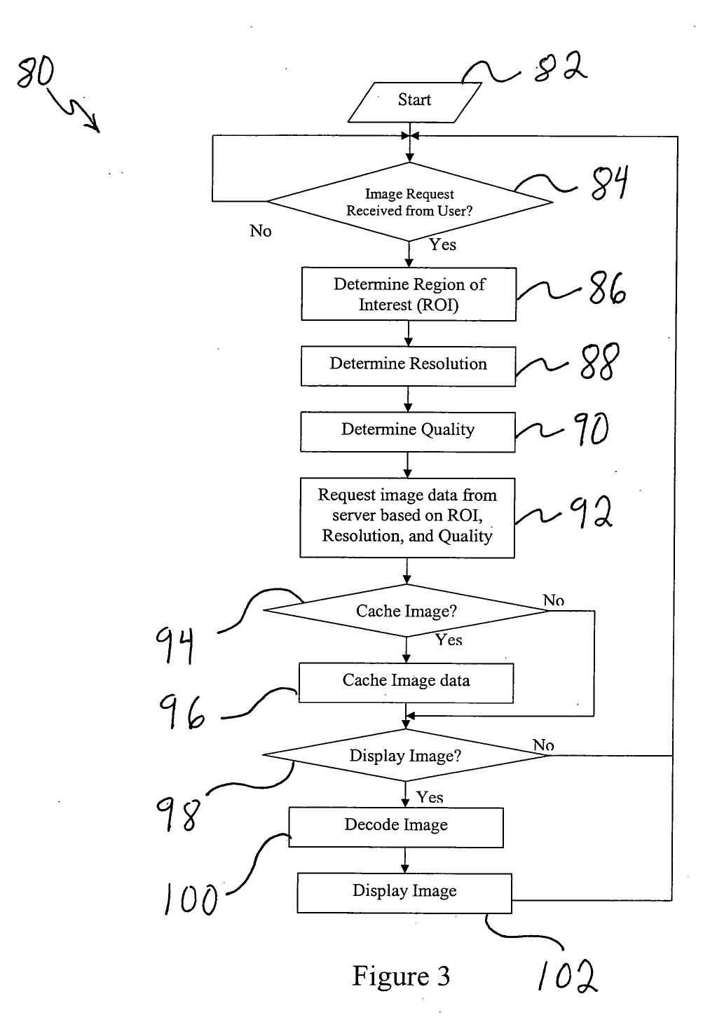

Referring now to FIG. 3, an algorithm 80 is executed by the the client 14 to retrieve and decode an image selection. The algorithm 80 begins with process step 82 in which variables and parameters are initialized. In process step 84, the algorithm 80 monitors request from a user for an image selection. If a user makes a request, the algorithm advances to process step 86 and determines a region of interest as defined by the user. The region of interest may be defined by one of a number of methods. The user may enter in a set of coordinates which define the region of interest. Alternatively, the region of interest may be defined based on a selection box, such as a bounding box in pixel coordinates, created by the user. Once the region of interest is determine in process step 86, the resolution is determined in process step 88. The resolution is an integer that is entered by the user or otherwise determined based on constraints selected by the user. In process step 90, the desired quality is determined. The quality may be defined as a bit rate or as the desired number of bitplanes to provide for reconstructing wavelet data. Once the region of interest, resolution, and quality have been determined, the algorithm 80 sends a request to the recoder 20 of the server 12 for the specified image data. The request includes the region of interest, resolution, and quality values. In response, the recoder retrieves and recodes the appropriate image data and resteams the data to the client 14.

In process step 94, the algorithm 80 determines if the restreamed compressed image data received from the recoder 20 is to be stored for later access or transmittal to other clients. If the image data is to be cached, the data is stored in the database 40 in process step 96. If the image data is not to be cached, the algorithm 80 advances to process step 98. In process step 98, the algorithm 80 determines if the image defined by the image data is to be displayed to the user. If so, the algorithm advances to process step 100 in which the image data is decoded and subsequently displayed to the user in process step 102 via the display 28 of the client 14. If the image is not to be displayed to the user, the algorithm 80 loops back to process step 84 to monitor for additional user requests.

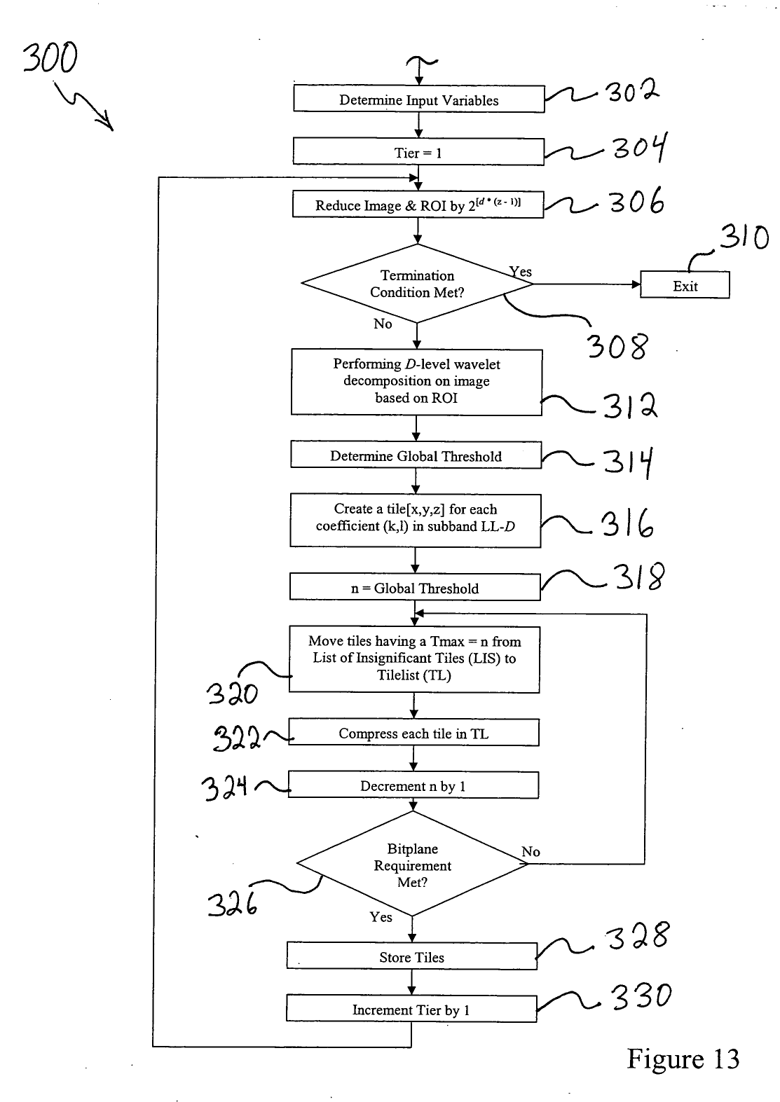

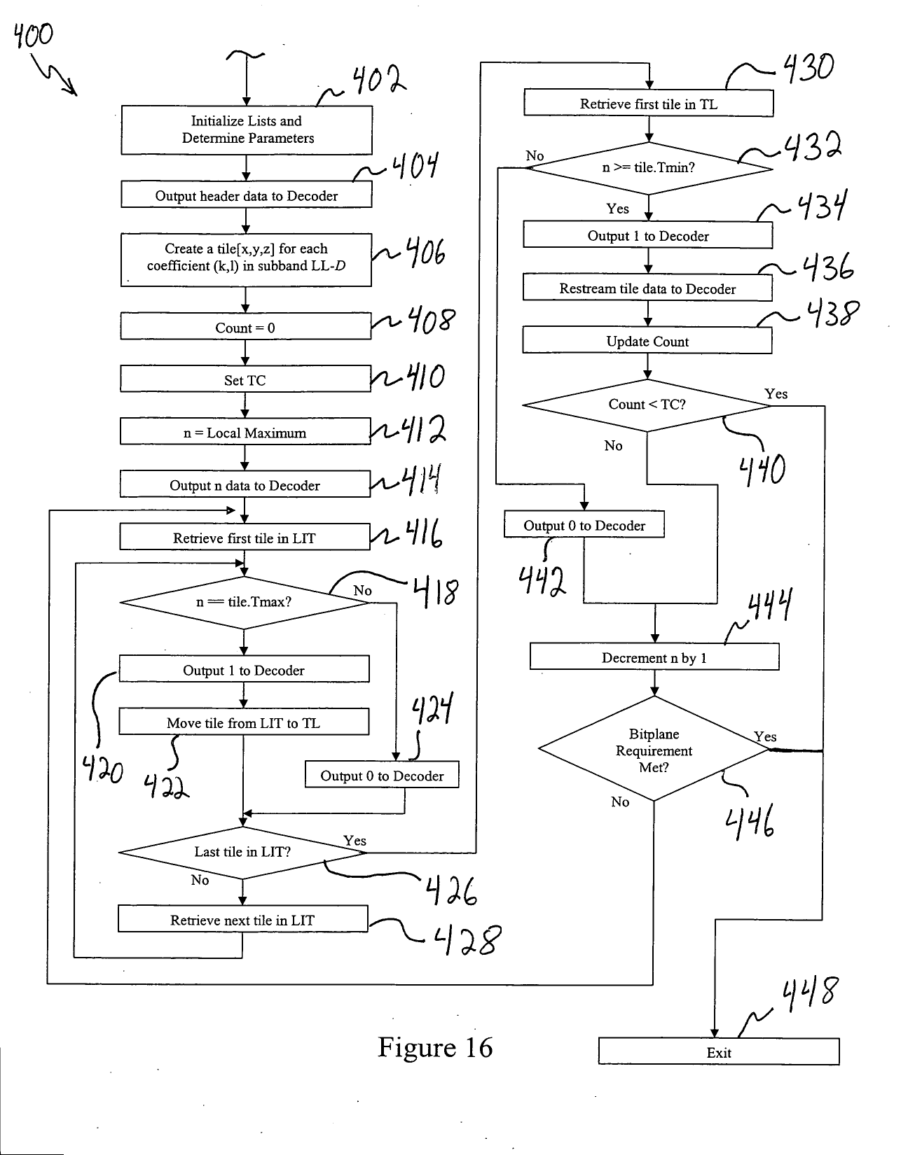

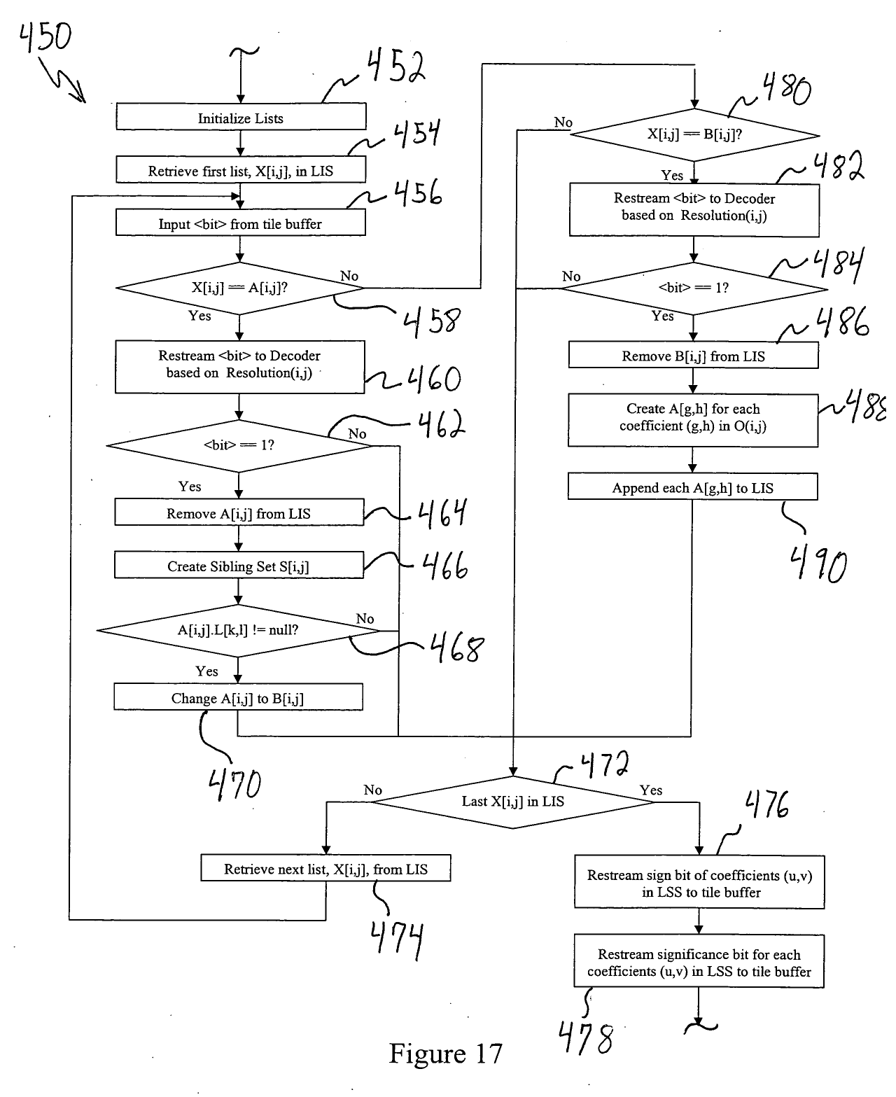

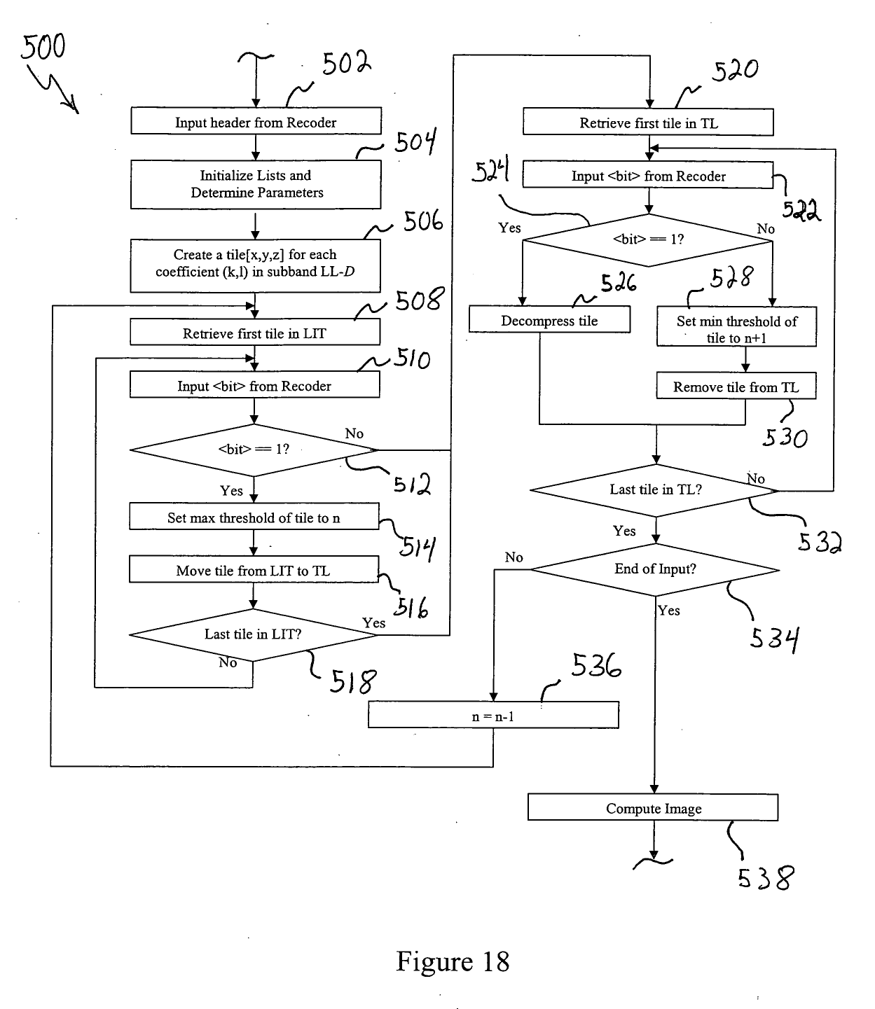

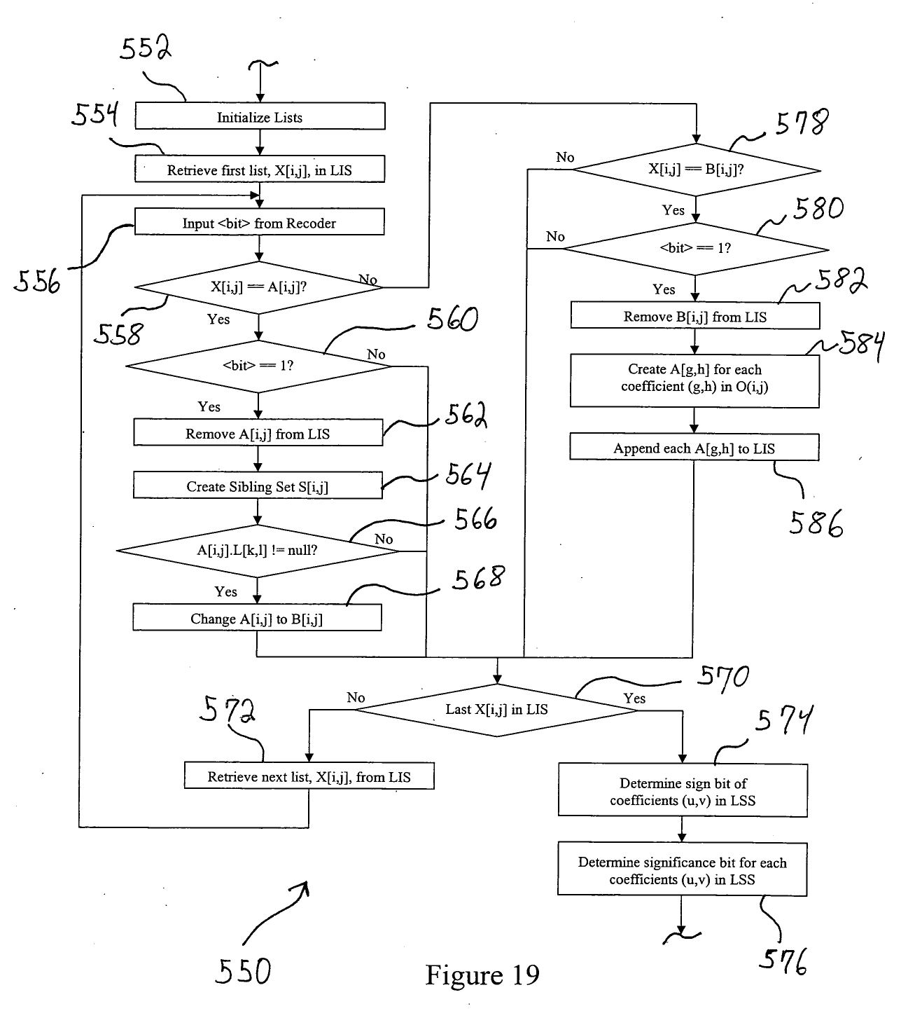

Referring now to FIGS. 13-19, algorithms 300, 400, 500 for preceding (FIGS. 13-15), recoding (FIGS. 16-17), and decoding (FIGS. 18-19), respectively, will be discussed. The algorithm 300 for precoding may be executed by the server 12 and may be embodied as the precoder 18. The algorithm 400 for recoding may be executed by the server 12 and/or the client 14 and may be embodied as the recoder 20 and 38, respectively. The algorithm 500 for decoding may be executed by the client 14 and may be embodied as the decoder 24.

Referring now to FIG. 13, an algorithm 300 for precoding an image begins with a process step 302 in which input variables are determined. In process step 302, the number of levels of decomposition, D, and the number of image resolutions skipped between tiers, d, are determined. The values of D and d may be provided to the algorithm 300 via the user, may be preset values, or may be determined by any other method. In addition, the image and the region of interest, ROI, are determined in process step 302. The image is determined based on the supplied image and is embodied as pixel map as described above in regard to FIG. 5. The ROI may be entered by the user via, for example, direct pixel integer entry or determined based on a bounding box selection. Alternatively, a default value may be assigned to ROI based on, for example, the values of D and/or d. Further, in process step 302, a Tilelist, TL, and a List of Insignificant Sets, LIS, are set to empty lists. After input variables have been determined in step 302, the algorithm advances to process step 304. In process step 304, the tier number, z, is set to 1. The algorithm 300 subsequently advances to process step 306 in which the image and the region of interest are reduced by a factor of 2\hat{ }[d*(z−1)]. As can be seen, when the tier number z is set to 1, as in the first iteration, no reduction occurs. The algorithm 300 checks for a termination condition in process step 308. If a termination condition exists, the algorithm 300 exits in process step 310. The termination condition may be embodied as any termination condition. For example, the algorithm 300 may terminate when the size of the image, after the most recent reduction of step 306, is too small for a D level wavelet transform. Alternatively, the algorithm 300 may terminate if a maximum tier value is achieved. Regardless, if the termination condition is not met in process step 308, the algorithm 300 advances to process step 312.

In process step 312, a D-level wavelet decomposition is computed on the image based on the ROI. The ROI defines a portion of the image on which the D-level wavelet decomposition is performed. The decomposition of the image based on the ROI produces a set of coefficients, Cd. In the subsequent process step 314 a global maximum, Tmax, is determined. The global maximum is determined by computing the log base 2 of the maximum coefficient in Cd. In process step 312, a tile is created for each coefficient (k,l) in the subband of LL-D. To do so, a structure tile[x,y,z], where x and y are the coordinate values of the particular coefficient offset by the database offset values dbx and dby, respectively, is created. The database offset values may be determined based on the ROI as discussed above in regard to and illustrated in FIG. 5. Each tile is initialized and the threshold maximum, Tmax, of the tile is subsequently set to the log base 2 of the maximum coefficient in contained in the tile.

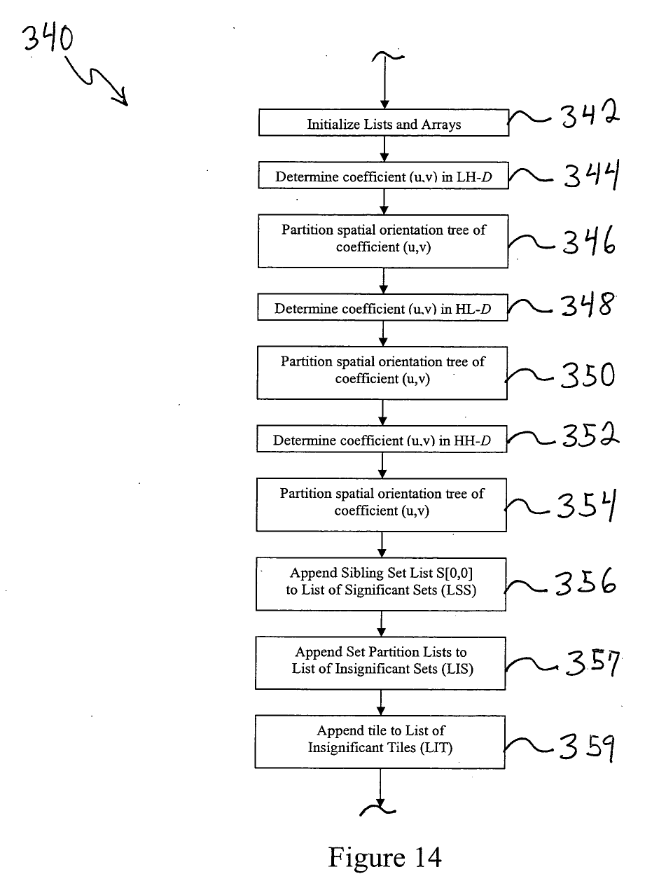

An algorithm 340 for initializing a tile is illustrated in FIG. 14. The algorithm 340 begins with process step 342 in which lists and arrays are initialized. In process step 342, a List of Insignificant Sets, LIS, is created for the tile. In addition, a List of Significant Sets, LSS, is created for each tile. The LIS includes sets which are determined to be insignificant for the current threshold while the LSS includes partition sets which are determine to be significant for the current threshold.. A sibling set list, S[0,0], and set partition lists A[0,1], A[1,0], and A[1,1] are created. The current coefficient, (k,l), is assigned to the S[0,0] and the signbit of the sibling set, S[0,0], is set to true.

After the lists and arrays have been initialized in process step 342, the algorithm 340 advances to step 344. In process step 344, the coefficient (u,v) in the LH-D subband which spatially corresponds to the current coefficient, (k,l), is determined. Subsequently, in process step 346, the algorithm 340 partitions the spatial orientation tree of coefficient (u,v). To do so, the coefficient (u,v) is assigned to the sibling set, S[0,0], the offspring of the coefficient (u,v) is assigned to partition set list A[0,1], and the descendents, not including the offspring, of coefficient (u,v) is assigned to the partition set list A[0,1]. An offspring, O(k,l), of a coefficient (k,l) is defined as:

O(k,l)={(2k, 21), (2k+1, 21), (2k, 21+1), (2k+1, 21+1)}

The descendents, not including the offspring, of a coefficient (k,l) is defined as:

L(k,l)={O(2k, 21), O(2k+1, 21), O(2k, 21+1), O(2k+1, 21+1),

L(2k, 21), L(2k+1, 21), L(2k, 21+1), L(2k+1, 21+1)}

The algorithm then advances to process step 348. In process step 348, the coefficient (u,v) in the HL-D subband which spatially corresponds to the current coefficient, (k,l), is determined. Subsequently, in process step 350, the algorithm 340 partitions the spatial orientation tree of coefficient (u,v). To do so, the coefficient (u,v) is assigned to the sibling set, S[0,0], O(u,v) is assigned to partition set list A[1,0], and L(u,v) is assigned to the partition set list A[1,0].

The algorithm proceeds to process step 352 in which the coefficient (u,v) in the HH-D subband which spatially corresponds to the current coefficient, (k,l), is determined. Subsequently, in process step 354, the algorithm 340 partitions the spatial orientation tree of coefficient (u,v). To do so, the coefficient (u,v) is assigned to the sibling set, S[0,0], O(u,v) is assigned to partition set list A[1,1], and L(u,v) is assigned to the partition set list A[1,1]. The sibling set, S[0,0], is appended to LSS in process step 356. In process step 357, the set partition lists, A[0,1], A[1,0], A[1,1], are append to the LIS in order. The algorithm 340 then advances to process step 359 in which the current tile is appended to a List of Insignificant Tiles, LIS. The algorithm 340 subsequently exits execution after the process step 359.

Referring back to FIG. 13, after the tiles for each coefficient in the LL-D subband are created, the algorithm 300 advances to process step 318 in which a variable n is set to the global threshold value. The algorithm 300 then advances to process step 320. In process step 320, any tiles having a maximum threshold, Tmax, equal to the current threshold, n, are removed from the LIT and appended to the TL.

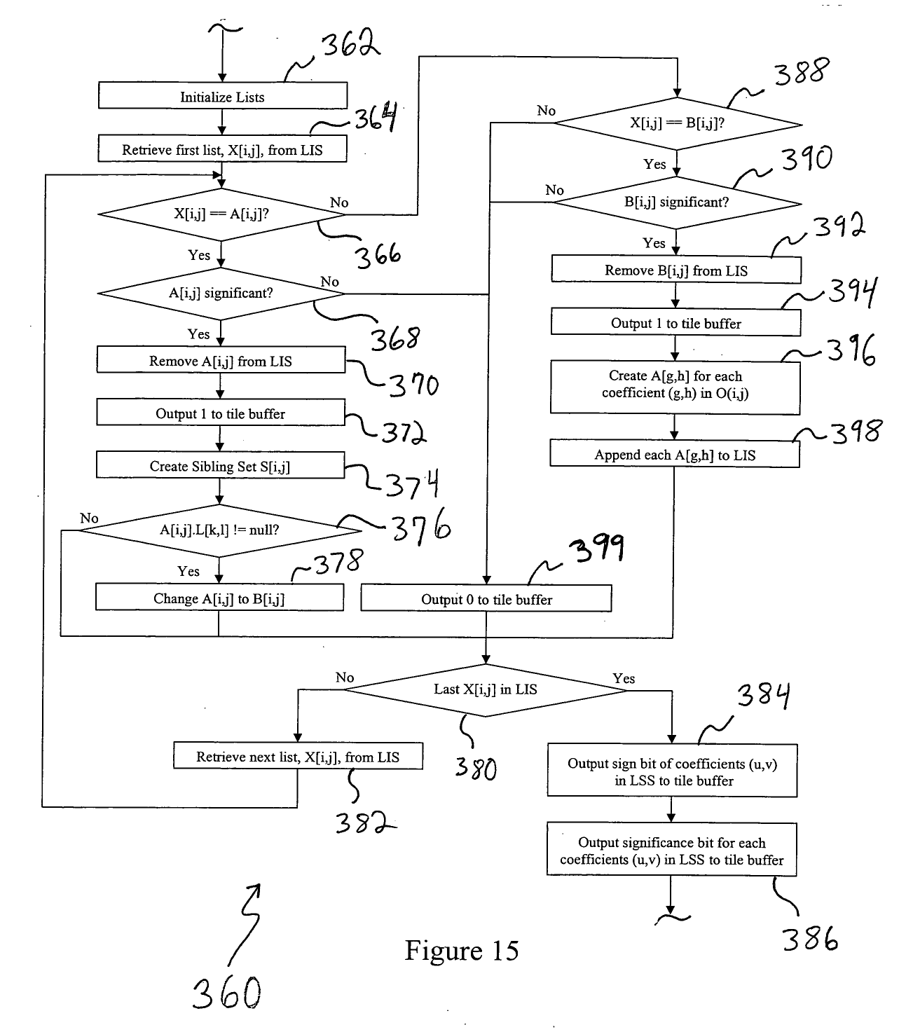

Each tile is subsequently compressed in process step 322. To do so, as illustrated in FIG. 15, a compression algorithm 360 is executed. The algorithm 360 begins with process step 362 in which a number of lists are initialized. In step 362, the List of Significant Sets for each decomposition level, LSS[#], is loaded with the LSS associated with the current tile. Similarly, the List of Insignificant Sets, LIS, is loaded with the LIS associated with the current tile. The algorithm 360 advances to process step 364 in which a first list, X[i,j], is retrieved from LIS. The algorithm 366 determines if X[i,j] is equal to A[i,j] in process step 366. If X[i,j] is not equal to A[i,j], the algorithm 360 proceeds to process step 388 which will be discussed below. However, if X[i,j] is equal to A[i,j], the algorithm 360 determines if A[i,j] is significant in process step 368. To do so, the algorithm 360 determines if any coefficient (u,v) in A[i,j]. O(k,l) and A[i,j].L(k,l) is significant for 2ⁿ, wherein n is the variable threshold. If A[i,j] is significant, the algorithm 360 removes A[i,j] from LIS in process step 370, outputs a 1 to the tile buffer in process step 372, and creates a sibling set S[i,j] in process step 374. In process step 374, a sibling set S[i,j] is created, the signbit associated with S[i,j] is set to true, A[i,j].O(k,l) is assigned to S[i,j], and S[i,j] is appended to LSS[#D] wherein #D is the present level of decomposition.

In process step 376, the algorithm 360 determines if A[i,j].L[k,l] is null. If so, the algorithm proceeds to process step 380. However, if A[i,j].L[k,l] is not null, A[i,j] is renamed to B[i,j] and B[i,j] is appended to the LIS in process step 378. The algorithm 360 then advances to process step 380. In process step 380, the algorithm 360 determines if the current X[i,j] is the last list in LIS. If not, the next X[i,j] in LIS is retrieved in process step 382 and the algorithm 360 subsequently loops back to process step 366. However, if the current X[i,j] is the last list in LIS, the algorithm advances to process step 384, which is discussed below.

Referring back to process step 366, if the current X[i,j] is not equal to A[i,j], the algorithm 360 advances to process step 388. In process step 388, the algorithm 360 determines if X[i,j] is equal to B[i,j]. If X[i,j] is not equal to B[i,j], the algorithm 360 proceeds to process step 399 which will be discussed below. However, if X[i,j] is equal to B[i,j], the algorithm 360 determines if B[i,j] is significant in process step 390. To do so, the algorithm 360 determines if any coefficient (u,v) in B[i,j].L(k,l) is significant for 2ⁿ, wherein n is the variable threshold. If B[i,j] is significant, the algorithm 360 removes B[i,j] from LIS in process step 392, outputs a 1 to the tile buffer in process step 394, and creates an A[g,h] for each coefficient in O(i,j) in process step 396. In addition, in process step 396, for each coefficient (u,v) in B[i,j].O(i,j), the offspring of (u,v), O(u,v), and the descendents not including the offspring, of (u,v), L(u,v), is assigned to A[g,h]. Subsequently, in process step 398, A[g,h] is appended to the LIS. The algorithm then proceeds to process step 380 to determine if the current X[i,j] is the last list in LIS. If the current X[i,j] is the last list in LIS, the algorithm 260 proceeds to process step 384. In process step 384, for each coefficient (u,v) of S[i,j].O(k,l) in LSS[#], wherein #=D . . . 1, the sign bit for the coefficient (u,v) is output to the tile buffer if S[i,j].signbit is set to true. The sign bit for the coefficient (u,v) is a 1 if the sign value of the coefficient (u,v) is positive and a 0 if the sign value of the coefficient (u,v) is negative. In process step 386, for each coefficient (u,v) of S[i,j].O(k,l) in LSS[#], wherein #=D . . . 1, a 1 is output to the tile buffer is the coefficient (u,v) is significant for the current variable threshold, n, and a 0 is output to the tile buffer if the coefficient (u,v) is not significant. The S[i,j].signbit is set to false to ensure that the sign bit is only output during the first processing. After the algorithm 360 has output the significance bit for the coefficients (u,v), the algorithm 360 exits back to the calling program.

Referring back to FIG. 13, after each tile has been compressed, the algorithm 300 advances to process step 322 in which the threshold variable, n, is decremented by one. The algorithm 300 then determines if the bitplane requirement, as specified by a quality variable, has been met. If not, the algorithm 300 loops back to process step 320 to reanalysis the tiles contained in LIS. Alternatively, if the bitplane requirement for the present image has been met, the algorithm 300 advances to process step 328. In process step 328, the data for each tile in TL is saved to the database 22. The tile data stored includes the threshold max for the tile, the threshold min for the tile, and the buffer associated with the tile. Once every tile in TL has been stored, the algorithm 300 advances to process step 330 in which the tier value is incremented by 1. Subsequently, the algorithm 300 loops back to the process step 306 in which the image and ROI are further reduced.

Referring now to FIG. 16, an algorithm 400 for recoding an image begins with a process step 402 in which variable lists are initialized and parameters are determined. In process step 402, the desired resolution, region of interest, and quality are determined. The quality may include a specified number of bitplanes for reconstructing wavelet data, bp, and/or a specified bit rate value, br. The resolution, region of interest and quality may be supplied to the recoder 20 by the client 14. In process step 402, the algorithm 400 also determines the tier level, z, containing the specified resolution. Additionally, database offsets, dbx and dby, are computed based on the specified resolution. Further, the algorithm 400 computes the parameters of coefficient array, Cd, based on the resolution and size of the region of interest. In process step 404, the algorithm 400 outputs the header data. To do so, the algorithm 400 outputs two integer values denoting the size of the coefficient array Cd and an integer value denoting the level of wavelet decomposition to the decoder 24. In addition, a Tilelist, TL, and a List of Insignificant Tiles, LIS, are set to empty lists

The algorithm 400 subsequently advances to process step 406 in which a tile is created for each coefficient (k,l) in subband LL-D of Cd. To do so, a structure tile[x,y,z], where x and y are the coordinate values of the particular coefficient offset by the database offset values dbx and dby, respectively, is created. Each tile is then initialized using the algorithm 340 discussed above in regard to FIG. 14. In addition, tile data is retrieved from the database 22 for each tile. The tile data includes the tile maximum threshold value, the tile minimum threshold value, and the tile buffer. In process step 408, a count is set to 0 and in process step 410 a target count is determined. The target count is determined by multiplying the bit rate by the size of the region of interest. In process step 412, a threshold variable, n, is set to a local maximum determined by finding the maximum coefficient of all tiles in LIT. The algorithm 400 subsequently advances to process step 414 in which the threshold variable, n, is output to the decoder 24.

The first tile in LIT is retrieved in process step 416. The algorithm 400 then advances to process step 418 in which the maximum threshold of the tile is compared to the variable threshold, n. If the thresholds are equal, the algorithm 400 advances to process step 420 in which a 1 is output to the decoder. In process step 422, the current tile is removed from the LIT and appended to TL. The algorithm then proceeds to process step 426.

Referring back to process step 418, if the maximum threshold of the tile is not equal to the variable threshold, n, the algorithm 400 advances to process step 424 in which a 0 is output to the decoder. The process flow of algorithm 400 then continues to process step 426. In process step 426, algorithm determines if the current tile is the last tile in LIT. If not, the algorithm 400 retrieves the next tile in LIT in process step 428 and subsequently loops back to process step 418.

Referring back to process step 426, if the current tile is the last tile in LIT, the algorithm 400 advances to process step 430 in which the first tile in TL is retrieved. In process step 432, the algorithm 400 determines if the variable threshold, n, is equal to or greater than the threshold minimum of the current tile. If not, the algorithm 400 advances to process step 442 in which a 0 is output to the decoder 24. The algorithm then proceeds to process step 444 in which the threshold variable, n, is decremented by 1. In process step 446, the algorithm 400 determines if the bitplane requirement has been met. To do so, the algorithm determines if n is greater than or equal to the global threshold minus the bitplane value. If the bitplane requirement has not been met yet, the algorithm 400 loops back to process step 416. However, if the bitplane requirement has been met the algorithm proceeds to process step 448 and exits.

Referring back to process step 432, if the if the variable threshold, n, is equal to or greater than the threshold minimum of the current tile then the algorithm 400 proceeds to process step 434. In process step 434, a 1 is output to the decoder 24. The algorithm 400 then proceeds to process step 436 in which tile data is restreamed to the decoder 24. An algorithm 450 for restreaming tile data is discussed below in regard to FIG. 17. After restreaming tile data to the decoder 24, the algorithm 400 advances to process step 438. IN process step 438, the count variable is updated. To do so, count is equated to the current count plus tile[x,y,z].count. In process step 440, the algorithm 400 determines if the count is less than the target count. If not, the algorithm 400 advances to process step 444 and decrements the threshold variable, n. However, if the count is less than the target count, the algorithm 400 advances to process step 448 and exits.

Referring now to FIG. 17, an algorithm 450 for restreaming tile data begins with process step 452 in which a number of lists are initialized. In step 452, the List of Significant Sets for each decomposition level, LSS[#], is loaded with the LSS associated with the current tile. Similarly, the List of Insignificant Sets, LIS, is loaded with the LIS associated with the current tile. The algorithm 450 advances to process step 454 in which a first list, X[i,j], is retrieved from LIS. In process step 456, the algorithm 450 inputs or retrieves a <bit> from the tile buffer associated with the current tile. The algorithm 450 determines if X[i,j] is equal to A[i,j] in process step 458. If X[i,j] is not equal to A[i,j], the algorithm 450 proceeds to process step 480 which will be discussed below. However, if X[i,j] is equal to A[i,j], the algorithm 450 restreams the <bit> to the decoder 24 if the resolution of (i,j) is less than the specified resolution value. The algorithm 450 then determines if the bit is equal to 1. If so, the algorithm 450 removes A[i,j] from LIS in process step 464 and creates a sibling set S[i,j] in process step 466. In process step 466, a sibling set S[i,j] is created, the signbit associated with S[i,j] is set to true, A[i,j].O(k,l) is assigned to S[i,j], and S[i,j] is appended to LSS[#D] wherein #D is the present level of decomposition.

In process step 468, the algorithm 450 determines if A[i,j].L[k,l] is null. If so, the algorithm 450 proceeds to process step 472. However, if A[i,j].L[k,l] is not null, A[i,j] is renamed to B[i,j] and B[i,j] is appended to the LIS in process step 470. The algorithm 450 then advances to process step 472. In process step 472, the algorithm 472 determines if the current X[i,j] is the last list in LIS. If not, the next X[i,j] in LIS is retrieved in process step 474 and the algorithm 450 subsequently loops back to process step 456. However, if the current X[i,j] is the last list in LIS, the algorithm 450 advances to process step 476, which is discussed below.

Referring back to process step 458, if the current X[i,j] is not equal to A[i,j], the algorithm 450 advances to process step 480. In process step 480, the algorithm 450 determines if X[i,j] is equal to B[i,j]. If X[i,j] is not equal to B[i,j], the algorithm 450 proceeds to process step 472. However, if X[i,j] is equal to B[i,j], the algorithm 450 restreams the <bit> to the decoder 24 if the resolution of (i,j)+1 is less than the specified resolution value. The algorithm 450 then determines if the bit is equal to 1 in process step 484. If so, the algorithm 450 removes B[i,j] from LIS in process step 486 and creates an A[g,h] for each coefficient in O(i,j) in process step 488. In addition, in process step 488, for each coefficient (u,v) in B[i,j].O(i,j), the offspring of (u,v), O(u,v), and the descendents not including the offspring, of (u,v), L(u,v), is assigned to A[g,h]. Subsequently, in process step 490, A[g,h] is appended to the LIS. The algorithm 450 then proceeds to process step 472 to determine if the current X[i,j] is the last list in LIS.

If the current X[i,j] is the last list in LIS, the algorithm 450 proceeds to process step 476. In process step 476, for each coefficient (u,v) of S[i,j.O(k,l) in LSS[#], wherein #=D . . . 1, a <bit> is retrieved from the tile buffer if S[i,j].signbit is set to true and the <bit> is subsequently output to the decoder 24 if the current decomposition level, #, is greater or equal to the specified resolution value. In process step 478, for each coefficient (u,v) of S[i,j]. O(k,l) in LSS[#], wherein #=D . . . 1, a <bit> is retrieved from the tile buffer and the <bit> is subsequently output to the decoder 24 if the current decomposition level, #, is greater or equal to the specified resolution value. The S[i,j].signbit is set to false to ensure that the sign bit is only output during the first processing. After the algorithm 450 has restreamed the significance bit for the coefficients (u,v), the algorithm 450 exits back to the calling program.

Referring now to FIG. 18, an algorithm 500 for decoding an image begins with a process step 502 in which header data is received from the recoder 20. The header data includes two integer values denoting the size of the coefficient array Cd and an integer value denoting the level of wavelet decomposition. In process step 504, a Tilelist, TL, and a List of Insignificant Tiles, LIS, are set to empty lists. The algorithm 500 advances to process step 506 in which a tile is created for each coefficient (k,l) in subband LL-D of Cd. To do so, a structure tile[x,y,z], where x and y are the coordinate values of the particular coefficient is created. The decoder 24 does not need to consider the database offsets. Each of the tiles are subsequently initialized using the tile initialization algorithm 340 illustrated in FIG. 14. Additionally, in process step 506 an integer value, n, is received from the recoder 20. The algorithm 500 then advances to process step 508 in which the first tile in LIT is retrieved. In process step 510, the algorithm 500 receives a <bit> from the recoder 20. The algorithm 500 determines if the <bit> is equal to 1 in process step 512. If the <bit> is equal to one, the algorithm 500 advances to process step 514 in which the maximum threshold for the current tile is set to the variable threshold n.

In process step 516 the current tile is removed form LIT and appended to the TL. The algorithm 500 determines if the current tile is the last tile in LIT. If no, the algorithm 500 loops back to process step 510. However, if the current tile is the last tile in LIT, the algorithm advances to process step 520. In process step 520, the first tile in TL is retrieved. A <bit> is received from the recoder 20 in process step 522. In process step 524, the algorithm determines if the <bit> is equal to 1. If so, the algorithm 500 decompress the current tile using a tile decompression algorithm 500 discussed below in regard to FIG. 19. The algorithm 500 subsequently advances to process step 532.

Referring back to process step 524, if the <bit> is not equal to one, the algorithm advances to process step 528 in which the minimum threshold of the current tile is set to n+1. The current tile is then removed from the TL in process step 530. The algorithm 500 then advances to process step 532. In process step 532, the algorithm 500 determines if the current tile is the last tile in TL. If the current tile is not the last tile in TL, the algorithm 500 loops back to the process step 522. However, if the current tile is the last tile in TL, the algorithm 500 advances to process step 534. In process step 534, the algorithm 500 determines if it is the end of the input from the recoder 20. If not, the variable threshold, n, is decremented by 1 in process step 536 and the algorithm loops back to process step 508. However, if it is the end of the input from the recoder 20, the algorithm 500 advances to process step 538. In process step 538, the image is computed based on the coefficients existing in Cd. To do so, a reverse wavelet decomposition is performed on the coefficients in Cd and the resulting image is displayed to the user on the client machine 12.

Referring now to FIG. 19, an algorithm 550 for decompressing a tile begins with process step 552 in which a number of lists are initialized. In step 552, the List of Significant Sets for each decomposition level, LSS[#], is loaded with the LSS associated with the current tile. Similarly, the List of Insignificant Sets, LIS, is loaded with the LIS associated with the current tile. The algorithm 550 advances to process step 554 in which a first list, X[i,j], is retrieved from LIS. In process step 556, the algorithm 550 inputs or retrieves a <bit> from the recoder 20. The algorithm 450 determines if X[i,j] is equal to A[i,j] in process step 558. If X[i,j] is not equal to A[i,j], the algorithm 550 proceeds to process step 578 which will be discussed below. However, if X[i,j] is equal to A[i,j], the algorithm 550 proceeds to process step 560. In process step 560, the algorithm 550 determines if the <bit> is equal to 1. If so, the algorithm 550 removes A[i,j] from LIS in process step 562 and creates a sibling set S[i,j] in process step 564. In process step 564, a sibling set S[i,j] is created, the signbit associated with S[i,j] is set to true, A[i,j].O(k,l) is assigned to S[i,j], and S[i,j] is appended to LSS[#D] wherein #D is the present level of decomposition.

In process step 566, the algorithm 550 determines if A[i,j].L[k,l] is null. If so, the algorithm 550 proceeds to process step 570. However, if A[i,j].L[k,l] is not null, A[i,j] is renamed to B[i,j] and B[i,j] is appended to the LIS in process step 568. The algorithm 550 then advances to process step 570. In process step 570, the algorithm 550 determines if the current X[i,j] is the last list in LIS. If not, the next X[i,j] in LIS is retrieved in process step 572 and the algorithm 550 subsequently loops back to process step 556. However, if the current X[i,j] is the last list in LIS, the algorithm 450 advances to process step 574, which is discussed below.

Referring back to process step 558, if the current X[i,j] is not equal to A[i,j], the algorithm 550 advances to process step 578. In process step 578, the algorithm 550 determines if X[i,j] is equal to B[i,j]. If X[i,j] is not equal to B[i,j], the algorithm 550 proceeds to process step 570. However, if X[i,j] is equal to B[i,j], the algorithm 550 determines if the <bit> is equal to 1 in process step 580. If so, the algorithm 550 removes B[i,j] from LIS in process step 582 and creates an A[g,h] for each coefficient in O(i,j) in process step 584. In addition, in process step 584, for each coefficient (u,v) in B[i,j].O(i,j), the offspring of (u,v), O(u,v), and the descendents not including the offspring, of (u,v), L(u,v), is assigned to A[g,h]. Subsequently, in process step 586, A[g,h] is appended to the LIS. The algorithm 550 then proceeds to process step 570 to determine if the current X[i,j] is the last list in LIS.

If the current X[i,j] is the last list in LIS, the algorithm 550 proceeds to process step 574. In process step 574, for each coefficient (u,v) of S[i,j].O(k,l) in LSS[#], wherein #=D . . . 1, a <bit> is received from the recoder 20 if S[i,j].signbit is set to true and the sign value of the coefficient (u,v) is set to positive if the <bit> equals 1 and to negative if <bit> equals 0. In process step 578, for each coefficient (u,v) of S[i,j].O(k,l) in LSS[#], wherein #=D . . . 1, a <bit> is received from the recoder 20 and the significance of the <bit> is set to true if <bit> is equal to one and to false otherwise. The S[i,j].signbit is set to false to ensure that the sign bit is only received during the first processing. After the algorithm 550 has determined the significance bit for the coefficients (u,v), the algorithm 550 exits back to the calling program.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method and system described herein. It will be noted that alternative embodiments of the method and system of the present disclosure may not include all of the features described yet still benefit from at least some of the advantages of such features. Those of ordinary skill in the art may readily devise their own implementations of the method and system that incorporate one or more of the features of the present invention and fall within the spirit and scope of the present disclosure as defined by the appended claims.

1. A method of compressing an image, the method comprising
decomposing the image into a number of tiers; and
partitioning at least one tier into a wavelet tile.

2. The method of claim 1, wherein the decomposing step comprises performing a number of wavelet transforms on the image.

3. The method of claim 1, wherein each of the number of tiers comprises a predetermined number of wavelet decompositions of the image.

4. The method of claim 1, further comprising determining a region of interest of the image.

5. The method of claim 4, wherein the decomposing step comprises decomposing the image into a number of tiers based on the region of interest.

6. The method of claim 1, wherein the partitioning step comprises determining a spatial orientation tree of the at least one tier.

7. The method of claim 6, wherein the spatial orientation tree has a root in the highest decomposition level of the at least one tier.

8. The method of claim 1, further comprising compressing the wavelet tile.

9. The method of claim 8, wherein the compressing step comprises zero tree compressing the wavelet tile.

10. The method of claim 8, further comprising storing the wavelet tile after the compression step.

11. The method of claim 10, wherein the storing step comprises storing the wavelet tile after the compression step based on the region of interest.

12. A method of distributing image data to a user, the method comprising
determining a region of interest of an image supplied by the user;
determining a resolution of the image supplied by the user;
determining a quality level of the image supplied by the user;
transmitting image data to the user, the image data being based on the region of interest, resolution, and quality level.

13. The method of claim 12, wherein the transmitting step comprises transmitting the data over a network.

14. The method of claim 13, wherein the network comprises the Internet

15. The method of claim 12, wherein the transmitting step comprises transmitting image data from a server to a client.

16. The method of claim 12, wherein the method includes compressing an image to form the image data.

17. The method of claim 16, wherein the compressing step includes storing the image data in a database.

18. The method of claim 12, further comprising decompressing the image data to form an image.

19. The method of claim 17, further comprising displaying the image to the user.

20. A system for distributing images, the system comprising:
a precoder configured to compress and store an image;
a recoder configured to select and reorganize a portion of the image based on a region of interest value, a resolution value, and a quality level value, the recoder transmitting the portion of the image as a bit stream;
a decoder configured to receive the bit stream and convert the bit stream to an image.
